(19) United States
(12) Patent Application Publication
(10) Pub. No.: US 2014/0219441 A1
(43) Pub. Date: Aug. 7, 2014

(54) VOICE ECHO CANCELLATION METHOD AND SYSTEM

(71) Applicant: Lloyd Trammell, Thousand Oaks, CA (US)

(72) Inventor: Lloyd Trammell, Thousand Oaks, CA (US)

(73) Assignee: Max Sound Corporation, La Jolla, CA (US)

(21) Appl. No.: 14/172,587

(22) Filed: Feb. 4, 2014

Related U.S. Application Data
(60) Provisional application No. 61/760,538, filed on Feb. 4, 2013.

(51) Int. Cl. H04M 3/00

(52) U.S. Cl. CPC H04M 3/002
USPC 379/406.12

(57) ABSTRACT

A Voice Echo Cancellation system and process are disclosed. According to one embodiment, the present invention comprises an input audio source that is converted to a digital signal via a PCM convertor where the amplitude of the input audio source is sampled at regular intervals and translated into digital PCM audio. The resulting PCM audio is analyzed for its dynamic and harmonic content. Corrective sound waves are then generated that reduce the repetition of the original audio (echos). The corrective sound waves are applied to the repeating audio echoes to create corrected sound waves. The corrected audio is then outputted from the system. The analyzing step of the Voice Echo Cancellation process of the present invention comprises performing an evaluation of the PCM audio for dynamic and harmonic content; identifying repetitive harmonic content (echos) of the PCM audio; determining a scale based on the ratio of the amplitude of the first repeat harmonic to the amplitude of the input PCM audio; generating sound waves with descending amplitude levels according to the determined scale; and phase shifting the newly generated sound waves to generate corrective sound waves. The phase shift of the inventive Voice Echo Cancellation process is 90 to 180 degrees.

### CROSS-REFERENCE TO RELATED PATENT APPLICATIONS

Embodiments of the present invention relate to U.S. Provisional Application Ser. No. 61/760,538, filed Feb. 4, 2013, entitled “AUDIO ECHO CANCELLATION”, the contents of which are incorporated by reference herein and which is a basis for a claim of priority.

### BACKGROUND OF THE INVENTION

The present invention relates to a method and device for enhancing an audio source by reducing and eliminating the repetitive harmonic sound waves known as echoes, in the sound wave.

Voice communications typically include repetitive harmonics, better known as echoes, which prevent a listener from experiencing the best sound from the source. The term echo cancellation is conventionally used to describe the process of removing echoes from a voice communication in order to improve voice quality. In addition to improving quality, echo cancellation has been used to increases capacity by preventing echoes from traveling across a network.

Conventional echo cancellation techniques involve recognizing the echoes in the transmitted or received signal. Once the echo is recognized, it can be removed by ‘subtracting’ it from the transmitted or received signal. This technique is implemented using a digital signal processor (DSP) or software. The conventional techniques calculate an estimate of the echo from the original input signal.1 This technique requires adaptive signal processing to generate a signal accurate enough to effectively cancel the echo, where the echo can differ from the original due to various kinds of degradation along the way. ^{1 1} See, e.g., http://en.wikipedia.org/wiki/Echo cancellation

By requiring an estimate of the echo, the conventional techniques suffer from inherent uncertainties and inaccuracies created by the “guessing game.” What is required is an echo cancellation technique that is not reliant on guessing or estimating the echo signal, but instead is based on a dynamic, determinative process that is based on determination of the echo.

### SUMMARY OF THE INVENTION

The inventive Voice Echo Cancellation (V.E.C.) process operates to reduce and eliminate repeat sound signals (echos) in sound originating from various sources such as a microphone, phone, CD, movies, and the like. The inventive VEC process is based on dynamic and self adjusting properties that will allow for the lessening of harmonic content in any repetitive harmonics that may be present without resorting to guessing and estimating of the echo sound.

According to one embodiment, the inventive Voice Echo Cancellation process of the present invention comprises an input audio source. The input audio source is converted to a digital signal via a PCM convertor where the amplitude of the input audio source is sampled at regular intervals and translated into digital PCM audio. The resulting PCM audio is analyzed for its dynamic and harmonic content. Corrective sound waves are then generated that reduce the repetition of the original audio (echos). The corrective sound waves are applied to the repeating audio echoes to create corrected sound waves. The corrected audio is then outputted from the system.

The analyzing step of the Voice Echo Cancellation process of the present invention comprises performing an evaluation of the PCM audio for dynamic and harmonic content; identifying repetitive harmonic content (echos) of the PCM audio; determining a scale based on the ratio of the amplitude of the first repeat harmonic to the amplitude of the input PCM audio; generating sound waves with descending amplitude levels according to the determined scale; and phase shifting the newly generated sound waves to generate corrective sound waves.

The phase shift of the inventive Voice Echo Cancellation process is between 90 and 180 degrees.

### BRIEF DESCRIPTION OF THE DRAWINGS

FIG. 1 is a flow chart showing the various steps of an exemplary embodiment of the Voice Echo Cancellation Module according to the present invention.

FIG. 2 is a flow chart showing an exemplary embodiment showing a system incorporating the Voice Echo Cancellation Module according to the present invention.

FIG. 3 is an illustration of an application of the Voice Echo Cancellation Module according to the present invention.

### DETAILED DESCRIPTION OF THE PREFERRED EMBODIMENT(S)

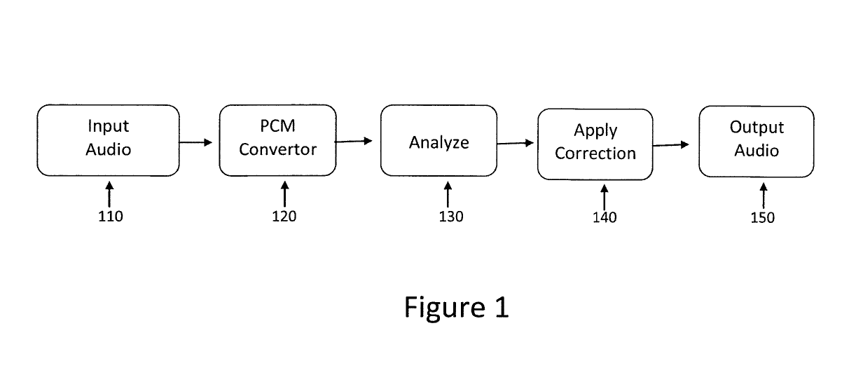

An embodiment of the echo cancellation technique of the present invention is described and shown in the flow chart of FIG. 1. Preferably, the inventive VEC process is performed by a single module as shown in the flow chart of FIG. 1. Input audio (101) can be any audio source such as audio received through a microphone, phone, TV, CD and the like.

Input audio (101) is provided to a PCM convertor (102) where the amplitude of the sound wave is sampled at regular intervals and translated into digital PCM audio suitable for transmission. The Analyze step (103) performs an evaluation and analysis of the PCM audio for its dynamic and harmonic content. In particular, in this step PCM audio is analyzed for repetitive harmonic content and the first repetitive harmonics are analyzed and differences in their amplitudes are determined.

This determination, in turns, provides a scale for the identification of the subsequent harmonics as one skilled in the art would appreciate that the subsequent harmonics will also be distributed according to the same determined scale. The determined scale will then act as the basis for the dynamic reduction amounts that are to be identified in the subsequent repeats.

These reductions are used to calculate and create new harmonic content with descending amplitude levels according to the determined scale. These newly created sound waves are in turn applied to the original repeating audio waves (echoes) in varying phase shift of 180 to 90 degrees, depending on the amplitude of the echoes, in a negative direction. The resulting combination of the original sound waves and the newly created audio sounds will result in a cancellation of the repetitions present in the original audio sound.

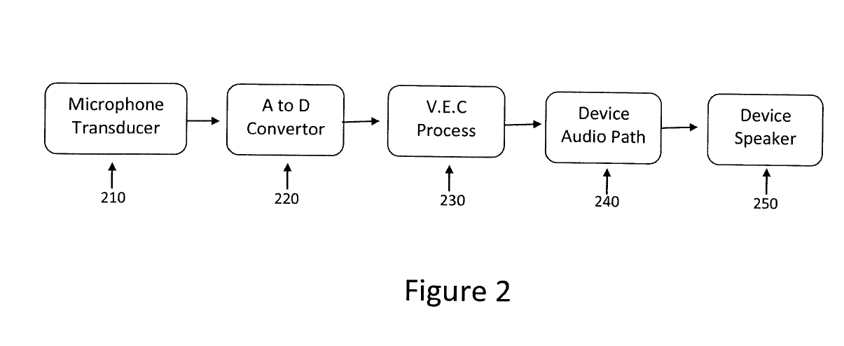

FIG. 2 is a flow chart showing a high-level operation and function of the inventive V.E.C. module according to an embodiment of the present invention. Accordingly, in the first step, 210, audio signal is received via a microphone transducer. The signal received via the Microphone transducer 220 is then fed to an analog to digital convertor 220 in the device, where the received signal is converted to a digital signal.

The converted digital signal is then fed to the inventive V.E.C. module 230, which analyzes the audio and immediately starts searching for repetitive harmonic content. As the V.E.C. process is applied to the repetitive harmonics as described above, it results in the lessening of harmonic content in any repetitive harmonics (echoes) and adjust itself accordingly.

As explained above, upon identification of the repetitive harmonics, there will be a comparison of this new repeat of the harmonic for amplitude and the process will change the phase of the harmonic by 90 to 180 degrees, while lessening the amplitude by the difference in each repeat. The reduction of each repeat sound wave will be dynamic. The V.E.C. processed audio then passes through the device audio path 240 to the device speaker, 250, where listener can hear it.

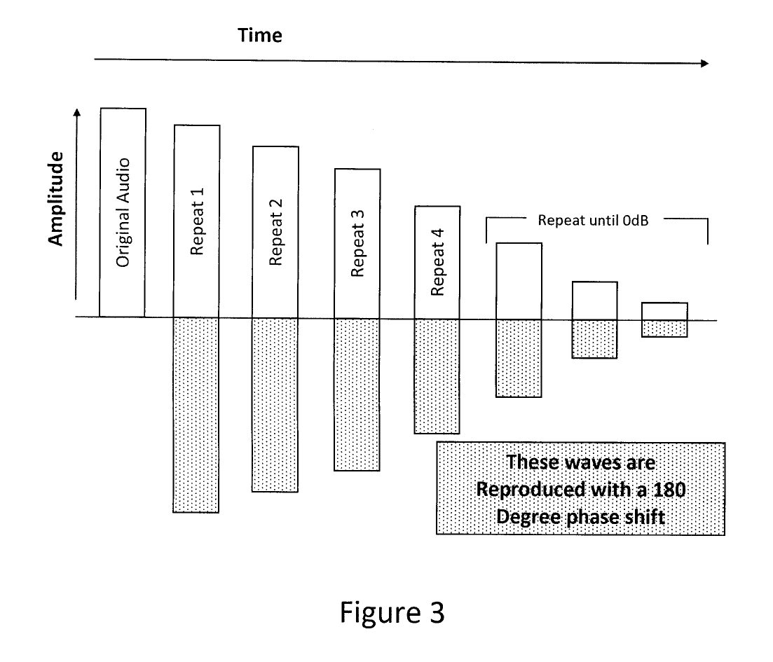

FIG. 3 depicts a diagram that shows an example of acoustic repeats (echoes) that are successively reduced in amplitude until no longer present. As explained above, the inventive V.E.C. process measures each of these repeat sound waves with the smaller amplitudes and digitally reproduces the same waveform in a 90 to 180 degree phase shifted version with the amplitude of every repeat matching the source repeat. The reproduced waveform is then added back to its corresponding echo, resulting in a dynamic cancellation of the echoes.

What is claimed is:

1. A Voice Echo Cancellation process comprising:
Providing an input audio source;
Converting the input audio source to a digital signal via a PCM convertor where the amplitude of the input audio source is sampled at regular intervals and translated into digital PCM audio;
Analyzing the PCM audio for dynamic and harmonic content;
Generating corrective sound waves that reduce the repetition of the original audio (echos);
Applying the corrective sound waves to the repeating audio echoes to create corrected sound waves;
Outputting the corrected audio with diminished echos.

2. The Voice Echo Cancellation process of claim 1, wherein the analyzing step comprises:
Performing an evaluation of the PCM audio for dynamic and harmonic content;
Identifying repetitive harmonic content (echos) of the PCM audio;
Determining a scale based on the ratio of the amplitude of the first repeat harmonic to the amplitude of the input PCM audio;
Generating sound waves with descending amplitude levels according to the determined scale; and
Phase shifting the newly generated sound waves to generate corrective sound waves.

3. The Voice Echo Cancellation process of claim 2 wherein the phase shift is between 90 and 180 degrees.

4. The Voice Echo Cancellation process of claim 1 wherein the corrected audio is substantially free or repeating audio waves (echos).
